(19) United States
(12) Patent Application Publication
(10) Pub. No.: US 2026/0181723 A1
(43) Pub. Date: Jun. 25, 2026

(54) Layer 1/Layer 2 Triggered Mobility Cell Switch

(71) Applicant: Telefonaktiebolaget LM Ericsson (publ), Stockholm (SE)

(72) Inventors: Pontus Wallentin, Linköping (SE); Icaro Leonardo Da Silva, Solna (SE); Stefan Wager, Espoo (FI); Antonino Orsino, Kirkkonummi (FI)

(21) Appl. No.: 19/126,481

(22) PCT Filed: Oct. 31, 2023
(86) PCT No.: PCT/SE2023/051091

§ 371 Date: May 1, 2025

Related U.S. Application Data
(60) Provisional application No. 63/422,654, filed on Nov. 4, 2022.

(51) Int. Cl. H04W 76/27; H04W 24/02; H04W 84/04

(52) U.S. Cl. CPC H04W 76/27; H04W 24/02; H04W 84/045

(57) ABSTRACT

A method performed by a user equipment, UE, the method comprising: receiving (201, 701) a Layer 1/Layer 2-triggered mobility, LTM, configuration of one or more LTM candidate target cells, wherein the one or more LTM candidate target cells comprise a first target cell; receiving (202, 702) a first command to execute an LTM cell switch to the first target cell; obtaining (203, 703) a first Layer 2, L2, reset indication comprising an indication of whether an L2 reset should be performed during the LTM cell switch to the first target cell; and executing (204, 704) the LTM cell switch to the first target cell according to the first command.

### TECHNICAL FIELD

This disclosure relates to the field of telecommunication networks, and in particular to methods and apparatuses for Layer 1/Layer 2 triggered mobility, LTM, cell switch.

### BACKGROUND

### L1/L2-Triggered Mobility

In the Third Generation Partnership Project (3GPP) Release 18, a work item known as Further New Radio (NR) mobility enhancements has been agreed. This work item includes a technical area entitled Layer 1 (L1)/Layer 2 (L2)-based inter-cell mobility. According to the Work Item Description (WID): RP-222332, 3GPP work item description: Further NR mobility enhancements (by MediaTek, 3GPP TSG RAN Meeting #97-e, Electronic Meeting, Sep. 12-16, 2022), when the user equipment (UE) moves from the coverage area of one cell to another cell, at some point a serving cell change needs to be performed. Currently, serving cell change is triggered by Layer 3 (L3) measurements and is done by Radio Resource Control (RRC) signalling triggered Reconfiguration with Synchronisation for change of Primary Cell (PCell) and PSCell (which is a Primary Secondary Cell in Long Term Evolution (LTE), and a Primary Secondary Cell Group (SCG) Cell in NR), as well as release add for Secondary Cells (SCells) when applicable. All cases involve complete L2 (and L1) resets, leading to longer latency, larger overhead and longer interruption time than beam switch mobility. The goal of L1/L2 based inter-cell mobility is to enable a serving cell change via L1/L2 signalling, in order to reduce the latency, overhead and interruption time.

In this work item, according to the WID RP-222332, the following is included as one objective of the work:

| 1. | To specify mechanism and procedures of L1/L2 based inter-cell mobility for mobility latency reduction: | |
|---|---|---|
| | ∘ | Configuration and maintenance for multiple candidate cells to allow fast application of |
| | | configurations for candidate cells [RAN2, RAN3] |
| | ∘ | Dynamic switch mechanism among candidate serving cells (including SpCell and SCell) for the |
| | | potential applicable scenarios based on L1/L2 signalling [RAN2, RAN1] |
| | ∘ | L1 enhancements for inter-cell beam management, including L1 measurement and reporting, and |
| | | beam indication [RAN1, RAN2] |

| | |
|---|---|
| - | Note 1: Early RAN2 involvement is necessary, including the possibility of further clarifying the |
| | interaction between this bullet with the previous bullet |

| | |
|---|---|
| ∘ | Timing Advance management [RAN1, RAN2] |
| ∘ | CU-DU interface signaling to support L1/L2 mobility, if needed [RAN3] |

Note 2: FR2 specific enhancements are not precluded, if any.
Note 3: The procedure of L1/L2 based inter-cell mobility are applicable to the following scenarios:

| | |
|---|---|
| ▪ | Standalone, CA and NR-DC case with serving cell change within one CG |
| ▪ | Intra-DU case and intra-CU inter-DU case (applicable for Standalone and CA: no new RAN |
| | interfaces are expected) |
| ▪ | Both intra-frequency and inter-frequency |
| ▪ | Both FR1 and FR2 |
| ▪ | Source and target cells may be synchronized or non-synchronized |

In 3GPP, discussions have started on solutions for L1/L2 based inter-cell mobility (which is also referred to as L1/L2-triggered mobility (LTM) or lower layer-triggered mobility).

A basic principle with L1/L2-triggered mobility is that the UE is pre-configured, by the network, with an RRC configuration per LTM candidate target cell, which is also known as a LTM candidate target cell configuration. Such a LTM candidate target cell configuration may be an RRCReconfiguration message or one or more Information Elements (IEs)/fields/parameters such as CellGroupConfig (comprising at least a Special Cell (SpCell) configuration and the configuration of one or more SCell(s) associated with the cell group e.g. Master Cell Group (MCG) or SCG). The UE performs lower layer measurements (e.g. Synchronisation Signal (SS) Reference Signal Received Power (RSRP) and/or L1 RSRP measurements) on these candidate LTM candidate target cells and transmits corresponding measurement reports to the network. The network then triggers the execution LTM cell switch, so the UE receives a lower layer signal (such as a Medium Access Control (MAC) Control Element (CE) or Downlink Control Information (DCI)), based on which the UE connects to the target cell and switches to a configuration of an LTM candidate target cell.

At the 3GPP RAN2 #119-e and RAN2 #119bis-e meetings, there were multiple agreements made on L1/L2-triggered mobility, and among these are the following:
A L1/L2 inter-cell mobility candidate (target) configuration is received within an RRC message before the L1/L2 dynamic switch is triggered.
RAN2 to use “LTM” as term for the L1/L2-triggered mobility.
Use the term “cell switch” for the procedure of triggering change of cells via the LTM feature
Use the term “Subsequent” LTM for the case when cell switch between L1/L2 mobility candidates is done without RRC reconfiguration in between.
RAN2 assumes that sequential L1/L2 cell change between Candidates without RRC reconfiguration can be supported.
RAN2 assumes L1/2 mobility trigger information is conveyed in a MAC CE, for further study (FFS) if the MAC CE or a DCI is used for the actual triggering.
RAN2 assumes the MAC CE for L1/2 mobility trigger contains at least a candidate configuration index.
R2 assumes that at L1L2 cell switch: Whether the UE performs partial or full MAC reset (FFS what partial reset is, e.g. to avoid data loss), re-establish Radio Link Control (RLC), perform data recovery with Packet Data Convergence Protocol (PDCP) is explicitly controlled by the network. R2 assumes that this can be configured by RRC. FFS if MAC CE indication(s) is/are needed.

At the RAN3 #117-e and RAN3 #117bis-e meetings, there were multiple agreements made on L1/L2 based inter-cell mobility, and among these are the following:

Both intra-DU and intra-CU inter-DU scenarios are supported for L1/L2 mobility.
RAN3 will aim for a single solution for network signaling design on L1/L2 based
inter-cell mobility to support all agreed scenarios.
The details of solution are FFS.
The gNB-CU initiates the L1/L2 mobility configuration procedure.
The configuration of candidate target cell(s) for L1/L2 mobility is initiated
by the gNB-CU.
WA: RAN3 assumes that the UE sends the L1 measurement report to the gNB-DU and
the gNB-DU triggers UE mobility to a target candidate cell. All details are up
to RAN1 and RAN2 discussion.
During L1/L2 handover configuration, the gNB-CU sends the suggested candidate
cell(s) to the gNB-DU in UE Context Modification
Request procedure, FFS in one message or multiple messages.
The gNB-DU may accept the target cells of L1/L2 handover and responds to the
gNB-CU with the access control result in UE Context Modification Response
message(s). gNB-DU may accept all or part of the target candidate cells.
gNB-DU initiated L1/L2 handover configuration is not allowed.
The UE sends the lower-layer measurement report to the gNB-DU and the gNB-DU
triggers UE mobility to a target candidate cell.
WA: The gNB-DU indicates the gNB-CU about the UE successful access to the
target cell by Access Success message. For inter-DU inter-cell mobility,
the UE Context Setup procedure is reused for handover configuration.

Further background information can be found in 3GPP Technical Specification 38.473, version 17.2.0, F1 application protocol (F1AP).

### SUMMARY

There currently exist certain challenge(s). In L3 mobility, both in LTE and NR, a L2 reset is always performed (at least a MAC reset), as part of a reconfiguration with sync procedure, as shown in the extract from 3GPP TS 38.331 shown below:

[38.331]
Reconfiguration with Sync 5.3.5.5.2

The UE shall perform the following actions to execute a reconfiguration with sync.
1> if the AS security is not activated, perform the actions upon going to RRC_IDLE as specified in 5.3.11 with the release cause ‘other’ upon which the procedure ends;
[ . . . ]
1> reset the MAC entity of this cell group;
[ . . . ]

As a main goal for L1/L2-triggered mobility is to reduce latency and interruption time, 3GPP RAN2 assumes that L2 is continued whenever possible (e.g. intra-distributed unit (intra-DU), without Reset, with the target to avoid data loss, and the additional delay of data recovery. However, as that may not be avoided in all scenarios (e.g. execution of an inter-DU LTM cell switch), a challenge is therefore how to avoid performing MAC reset, RLC re-establishment and PDCP recovery when they are not needed (e.g. for intra-DU cases) but still perform these actions in those cases when they are needed (e.g. for inter-DU cases). In other words, how is the UE to determine whether or not to perform a L2 reset during an LTM cell switch from a first cell to a candidate cell.

An additional challenge is to avoid RRC reconfiguration during subsequent LTM cell switch(es): i.e. when the UE is configured with LTM candidate target cell configuration(s) (e.g. Cell A, Cell B and Cell C) while connected to a first cell (e.g. SpCell X), e.g., with these cells associated to different Distributed Units (DU(s). This scenario is illustrated in FIG. 1. Then, the UE performs an LTM cell switch to a candidate cell (e.g. to Cell A, in the same DU as SpCell X), but still considers the previous LTM candidate target cells (e.g. Cell B and Cell C) as possible candidate cells. Assuming Cell X and Cell A are in the same DU, such a cell switch would not require a L2 reset.

Now, assume that the UE in Cell A moves to Cell B, and a L2 reset would be required (though it would also be required if that would have been from Cell X, so the UE can still apply the LTM candidate target cell configuration it received in Cell X). However, if the UE receives the LTM cell switch command (e.g. MAC CE) indicating a change to Cell C (from Cell B), then a L2 reset, in principle, would not be required (since Cell B and C are served by the same DU), though when the Cell C was configured, a L2 reset would be required (as the UE was in Cell X when Cell C was configured as a candidate). This results in the UE performing an unnecessary MAC reset, which increases the LTM cell switch delay. Similarly, if the UE subsequently receives an LTM switch command indicating a switch back to Cell A while being in Cell C, the stored target cell configuration would not include the MAC reset (as it was not needed for the LTM switch from Cell X to Cell A), but in this case MAC reset would be needed since Cell C and Cell A are served by different DUs. This means that the LTM cell switch will fail.

In summary, the challenge is that the situation regarding whether to perform these L2 resets may have changed, because a given candidate cell which was previously controlled by a different DU than the serving DU is, after a LTM cell switch, controlled by the serving DU or vice versa. In other words, it does not work for a subsequent LTM cell switch to configure an indication for L2 reset within an LTM candidate target cell configuration, as the need for L2 reset may change as the UE performs subsequent LTM cell switch executions.

Certain aspects of the disclosure and their embodiments may provide solutions to these or other challenges.

According to a first aspect, there is provided a method performed by a UE. The method comprises receiving an LTM configuration of one or more LTM candidate target cells. The one or more LTM candidate target cells comprise a first target cell. The method further comprises receiving a first command to execute an LTM cell switch to the first target cell; obtaining a first Layer 2 (L2) reset indication comprising an indication of whether an L2 reset should be performed during the LTM cell switch to the first target cell; and executing the LTM cell switch to the first target cell according to the first command.

According to a second aspect, there is provided a method performed by a network node serving a UE. The method comprises sending, to the UE, an LTM configuration of one or more LTM candidate target cells. The one or more LTM candidate target cells comprise a first target cell.

According to a third aspect, there is provided a UE comprising a processor and a memory, said memory containing instructions executable by said processor whereby said UE is operative to receive an LTM configuration of one or more LTM candidate target cells, where the one or more LTM candidate target cells comprise a first target cell. The UE is further operative to receive a first command to execute an LTM cell switch to the first target cell; obtain a first L2 reset indication comprising an indication of whether an L2 reset should be performed during the LTM cell switch to the first target cell; and execute the LTM cell switch to the first target cell according to the first command.

According to a fourth aspect, there is provided a UE adapted to perform the method according to any embodiments of the first aspect.

According to a fifth aspect, there is provided a network node comprising a processor and a memory, said memory containing instructions executable by said processor whereby said network node is operative to send, to the UE, an LTM configuration of one or more LTM candidate target cells. The one or more LTM candidate target cells comprise a first target cell.

According to a sixth aspect, there is provided a network node adapted to perform the method according to any embodiments of the second aspect.

According to a seventh aspect, there is provided a computer program product comprising a computer readable medium having computer readable code embodied therein, the computer readable code being configured such that, on execution by a suitable computer or processor, the computer or processor is caused to perform the method according to any embodiments of the first, second or third aspect.

Thus, this disclosure presents methods for a User Equipment (UE). In these methods, the UE is configured with a serving cell (e.g. an SpCell with possible one or more SCells). The UE receives a L1/L2-triggered mobility (LTM) configuration of a LTM candidate target cell and further receives a lower layer command for executing an LTM cell switch to a target cell, and further obtains an indication on whether or not to perform a L2 reset during the execution of the LTM cell switch. In response the UE performs an LTM cell switch, and based on the obtained indication the UE determines whether to perform L2 reset or not during the LTM cell switch.

In some methods, the UE receives a L1/L2-triggered mobility (LTM) configuration of a LTM candidate target cell for a first target cell and a LTM configuration of a LTM candidate target cell for a second target cell, and further receives a first lower layer command for executing an LTM cell switch to the first target cell, and further obtains an indication on whether to perform a L2 reset or not during the execution of the LTM cell switch. In response the UE performs an LTM cell switch to the first target cell, and based on the obtained indication determines whether to perform L2 reset or not during the LTM cell switch. Then, while in the first target cell, the UE receives a second lower layer command for executing an LTM cell switch to the second target cell, and further obtains an indication on whether to perform a L2 reset or not during the execution of the LTM cell switch. In response the UE performs an LTM cell switch to the second target cell, and based on the obtained indication determines whether to perform L2 reset or not during the LTM cell switch.

This disclosure also presents methods for a source network node, such as a source gNB, a source Distributed Unit or serving network node such as a serving DU. In the methods the source network node handles an indication on whether or not to perform a L2 reset during the execution of the LTM cell switch for a UE configured with a serving cell and an LTM configuration including one or more LTM candidate target cells.

In some methods, the indication on whether or not to perform a L2 reset during the execution of the LTM cell switch is transmitted to the UE. In some methods, the indication on whether or not to perform a L2 reset during the execution of the LTM cell switch is included in a MAC CE, e.g. the same MAC CE as the MAC CE with the LTM cell switch information, or in a separate MAC CE.

This disclosure also presents methods for a third network node (or serving network node), such as a (serving) Central Unit (CU), (serving) gNB-CU. In the methods the third network node handles an indication on whether or not to perform a L2 reset during the execution of the LTM cell switch for a UE configured with a serving cell and an LTM configuration including one or more LTM candidate target cells.

In some methods, the indication on whether or not to perform a L2 reset during the execution of the LTM cell switch is included in the configuration of a LTM candidate target cell.

In some methods, the indication on whether or not to perform a L2 reset during the execution of the LTM cell switch is transmitted to the UE.

This disclosure also presents methods for a first target network node, such as a first target gNB, a first target DU, or first target gNB-DU. In these methods, the first target network node is to handle an indication on whether or not to perform a L2 reset during the execution of the LTM cell switch for a UE configured with a serving cell (e.g. cell X) and an LTM configuration including one or more candidate cells for LTM.

In some methods, the indication on whether or not to perform a L2 reset during the execution of the LTM cell switch is transmitted to the UE. In some methods, the indication on whether or not to perform a L2 reset during the execution of the LTM cell switch is included in a MAC CE, e.g. the same MAC CE as the MAC CE with the LTM cell switch information, or in a separate MAC CE.

In some methods, the indication on whether or not to perform a L2 reset during the execution of the LTM cell switch is included in the configuration of a LTM candidate target cell.

In some methods, the indication on whether or not to perform a L2 reset during the execution of the LTM cell switch is transmitted to the third network node.

This disclosure also presents methods for a second target network node, such as a second target gNB, a second target DU, or second target gNB-DU. In these methods, the second target network node is to handle an indication on whether or not to perform a L2 reset during the execution of the LTM cell switch for a UE configured with a serving cell and an LTM configuration including one or more LTM candidate target cells.

In some methods, the indication on whether or not to perform a L2 reset during the execution of the LTM cell switch is included in the configuration of a LTM candidate target cell.

In some methods, the indication on whether or not to perform a L2 reset during the execution of the LTM cell switch is transmitted to the third network node.

Certain embodiments may provide one or more of the following technical advantage(s). The proposed solution enables the network to control the UE L2 reset during LTM cell switch as the UE moves along preconfigured candidate cells, avoiding the need to reconfigure LTM candidate configurations to avoid both unnecessary L2 resets and LTM failure for cases where a L2 reset would be needed.

### BRIEF DESCRIPTION OF THE DRAWINGS

Some of the embodiments contemplated herein will now be described more fully with reference to the accompanying drawings, in which:

FIG. 1 is a schematic illustration of a configuration of cells;

FIG. 2 is a flow chart illustrating a method performed by a UE in accordance with some embodiments;

FIG. 3 is a flow chart illustrating a method performed by a first network node in accordance with some embodiments;

FIG. 4 is a flow chart illustrating a method performed by a third network node in accordance with some embodiments;

FIG. 5 is a schematic illustration of a system structure in accordance with some embodiments;

FIG. 6 is a signalling diagram illustrating techniques in accordance with some embodiments;

FIG. 7 is a flow chart illustrating another method performed by a UE in accordance with some embodiments;

FIG. 8 is a flow chart illustrating a method performed by a UE in accordance with some embodiments;

FIG. 9 is a schematic of a communication system in accordance with some embodiments;

FIG. 10 is a block diagram showing a user equipment in accordance with some embodiments;

FIG. 11 is a block diagram showing a network node in accordance with some embodiments; and

FIG. 12 is a block diagram illustrating a virtualization environment.

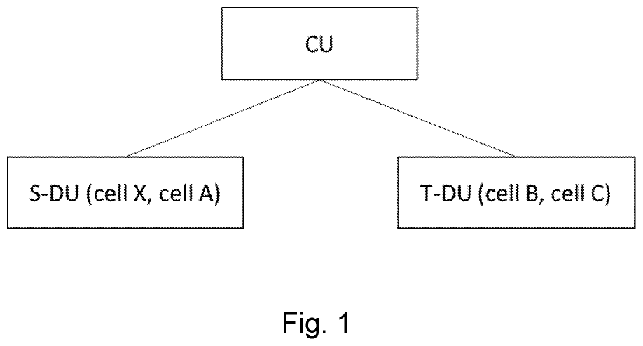

### DETAILED DESCRIPTION

Some of the embodiments contemplated herein will now be described more fully with reference to the accompanying drawings. Embodiments are provided by way of example to convey the scope of the subject matter to those skilled in the art.

This disclosure refers to the term “L1/L2 based inter-cell mobility” as used in the Work Item Description in 3GPP, though this disclosure also interchangeably also uses the terms L1/L2 mobility, lower layer mobility (LLM), L1/L2-triggered mobility (LTM), lower layer-triggered mobility (LTM), L1-mobility, L1 based mobility, L1/L2-centric inter-cell mobility or L1/L2 inter-cell mobility.

The basic principle for L1/L2 based inter-cell mobility is that the UE receives lower layer signalling from the network indicating to the UE a change of its serving cell (e.g. change of PCell, from a source to a target PCell), possibly with a change of beam to be monitored for a control channel e.g. a change of Transmission Configuration Indication (TCI) state. Here, “lower layer signalling” refers to a message or signalling of a lower layer protocol.

A lower layer protocol refers to a lower layer protocol in the air interface protocol stack relative to the RRC protocol. For example, Medium Access Control (MAC) is considered a lower layer protocol as it is “below” RRC in the air interface protocol stack, and in this case a lower layer signalling/message may correspond to a MAC Control Element (MAC CE). Another example of a lower layer protocol is the Layer 1 (or Physical Layer, L1), and in this case a lower layer signalling/message may correspond to Downlink Control Information (DCI). Another relevant aspect is that in a multi-beam scenario, a cell can be associated to multiple Synchronisation Signal Blocks (SSBs), and during a half-frame, different SSBs may be transmitted in different spatial directions (i.e. using different beams, spanning the coverage area of a cell). Similar reasoning may be applicable to Channel State Information-Reference Signal (CSI-RS) resources, which may also be transmitted in different spatial directions.

The phrase “LTM cell switch procedure” refers to the process of a UE changing its cell from a source cell to a target cell, using L1/L2-triggered mobility. In the context of L1/L2 based inter-cell mobility or L1/L2-triggered mobility (LTM), a LTM cell switch procedure may sometimes also be known as dynamic switch, LTM switch, (LTM) cell switch, (LTM) serving cell change or (LTM) cell change. Even if the term “change of cell” is used, that may comprise a change of a whole cell group configuration, which includes a change in the SpCell (e.g. change of PCell, or change of PSCell) and a change in SCells of the cell group (e.g. addition, modification and/or release of one or more SCells).

The phrase “lower layer signalling indicating to the UE the LTM cell switch procedure” is used herein to refer to a message/signal/indication that is sent by the source network node to the UE to provide the UE with the information required for the LTM cell switch procedure. The signalling being “lower layer” means that the signalling is at a layer of the protocol stack below the RRC layer, for example signalling in L1 and/or L2, such as a MAC CE. The UE starts executing the LTM cell switch procedure upon reception of the lower layer signalling indicating to the UE the LTM cell switch procedure. This does not, however, exclude that the UE may start executing the LTM cell switch procedure based on other triggers or events.

This disclosure refers to at least one configuration of a LTM candidate target cell and that the UE is configured with at least one LTM candidate target cell. This configuration may be an RRC configuration, such as encapsulated in an RRC Reconfiguration message, that the UE receives when being configured with inter-DU L1/L2 inter-cell mobility. The configuration of a LTM candidate target cell comprises the configuration which the UE needs to start to operate accordingly when it performs LTM cell switch procedure to that LTM candidate target cell, for example upon reception of the lower layer signalling indicating to the UE the LTM cell switch procedure to that LTM candidate target cell, which becomes the target cell and the current (new) SpCell, or an SCell in a serving frequency. The configuration of a LTM candidate target cell comprises parameters of a serving cell (or multiple serving cells, such as a cell group), comprising one or more of the groups of parameters, such as an RRCReconfiguration message an IE CellGroupConfig or an IE SpCellConfig (or the IE SCellConfig, in the case of a Secondary Cell). A configuration of a LTM candidate target cell may, in one example, comprise one or more of: (i) the PCell configuration and one or more SCell configuration(s) of a Master Cell Group (MCG); and (ii) the PSCell configuration and one or more SCell configuration(s) of a secondary Cell Group (SCG). The terms (LTM) candidate configuration, LTM configuration, (LTM) candidate target cell configuration, (LTM) target candidate (cell) configuration may be used interchangeably herein when referring to configuration of a LTM candidate target cell.

This disclosure refers to a serving cell. A serving cell is a cell configured for the UE, for example an SpCell, PCell, PSCell or SCell.

This disclosure refers to a source cell and a target cell. A source cell is a cell configured as a serving cell for the UE prior to the execution of the LTM cell switch procedure. A target cell is a cell configured as a serving cell, for example an SpCell, PCell, PSCell or SCell, for the UE after, or as a result of, the execution of the LTM cell switch procedure. The target cell may include a cell indicated in the lower layer signalling indicating to the UE the LTM cell switch procedure, or a cell configured as a result of the UE switching to the RRC configuration of a LTM candidate target cell provided by a configuration index in the lower layer signalling indicating to the UE the LTM cell switch procedure. In the context of a LTM cell switch procedure executed by the UE, a given cell may be either a source cell, a target cell, both a source cell and a target cell, or neither a source cell nor a target cell.

This disclosure refers to a “L2 reset”, which may be a MAC reset, a partial MAC reset, RLC re-establishment, PDCP data recovery, PDCP re-establishment, or any combination thereof. A “L2 reset flag” and an “indication of L2 reset/no L2 reset/partial L2 reset” both indicate whether to perform MAC reset, partial MAC reset, RLC re-establishment, PDCP data recovery, PDCP re-establishment or any combination thereof.

This disclosure also refers to “L2 reset indication” or “reset indication”, which is an indication on whether or not a UE is to perform a L2 reset during the execution of the LTM cell switch.

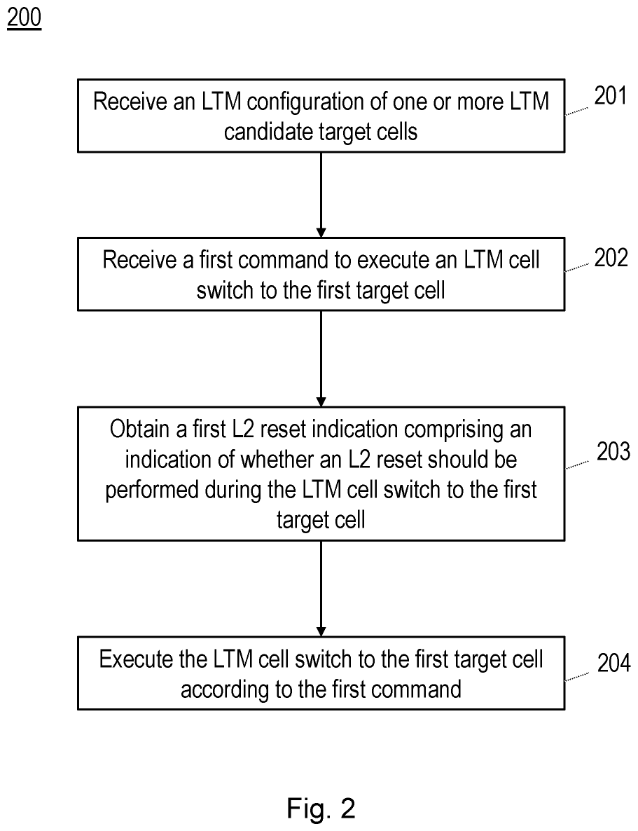

FIG. 2 is a flow chart illustrating a method 200 performed by a UE in accordance with some embodiments. The UE may be operating in dual connectivity with a MCG comprising a PCell, and at least a SCG comprising a PSCell.

The method 200 comprises, at step 201, receiving an LTM configuration of one or more LTM candidate target cells, where the one or more LTM candidate target cells comprise a first target cell. The LTM configuration may be received from a third network node, e.g., a Central Unit (CU) serving the UE. The LTM configuration may be received from a CU serving the UE or a Distributed Unit (DU) serving the UE. The LTM configuration may be comprised in a RRC Reconfiguration message.

The method 200 further comprises, at step 202, receiving a first command to execute an LTM cell switch to the first target cell. The first command may be comprised in a lower-layer signal. The first command may be comprised in an MAC CE or DCI. The first command to execute the LTM cell switch to the first target cell may be received from a first network node.

The method 200 further comprises, at step 203, obtaining a first L2 reset indication comprising an indication of whether an L2 reset should be performed during the LTM cell switch to the first target cell. The L2 reset may comprise a reset of one or more L2 protocols of a plurality of L2 protocols. The L2 reset may comprise a reset of only one or more L2 protocols of a plurality of L2 protocols.

L2 reset may comprise one or more of: a full L2 reset; a partial L2 reset; an MAC reset; a partial MAC reset; re-establishment; RLC re-establishment; PDCP re-establishment; data recovery; and PDCP data recovery of one or more L2 protocol sublayers and/or one or more L2 protocol entities configured for the UE.

The step 203 of obtaining the first L2 reset indication may comprise receiving the first L2 reset indication in the same L2 signalling as the LTM configuration of the first target cell, or receiving the first L2 reset indication in different L2 signalling to the LTM configuration of the first target cell. Thus, the first L2 reset indication may be included in (comprised in) the LTM configuration received in step 201. In these embodiments, the step 203 of obtaining the first L2 reset indication is achieved by step 201 of receiving the LTM configuration.

The step 203 of obtaining the first L2 reset indication may comprise receiving the first L2 reset indication from the first network node. The first network node may be a DU serving the UE. The first L2 reset indication may be received in an MAC CE.

The first L2 reset indication may relate to one or more of: an MAC entity, a cell group, an L2 protocol entity, a radio bearer, a data radio bearer, a signalling radio bearer or an RLC bearer. The first L2 reset indication may comprise a list of one or more cells, where an L2 reset should not be performed if the UE is in one of the listed cells when the UE executes a LTM cell switch.

The method 200 further comprises, at step 204, executing the LTM cell switch to the first target cell according to the first command. Executing the LTM cell switch to the first target cell may comprise determining, based on the first L2 reset indication, whether a L2 reset should be performed during the LTM cell switch to the first target cell. Executing the LTM cell switch may further comprise: responsive to determining that an L2 reset should be performed, performing the L2 reset during the LTM cell switch to the first target cell; and responsive to determining that an L2 reset should not be performed, executing the LTM cell switch to the first target cell without performing the L2 reset.

The one or more LTM candidate target cells may further comprise a second target cell. The method 200 may further comprise, after executing 204 the cell switch to the first target cell, receiving a second command to execute an LTM cell switch to the second target cell. The method 200 may comprise obtaining a second L2 reset indication comprising an indication of whether an L2 reset should be performed during the LTM cell switch to the second target cell; and executing the LTM cell switch to the second target cell according to the second command.

Executing the LTM cell switch to the second target cell may comprise determining, based on the second L2 reset indication, whether a L2 reset should be performed during the LTM cell switch to the second target cell. The method may further comprise: responsive to determining that an L2 reset should be performed, performing the L2 reset during the LTM cell switch to the second target cell; and responsive to determining that an L2 reset should not be performed, executing the LTM cell switch to the second target cell without performing the L2 reset.

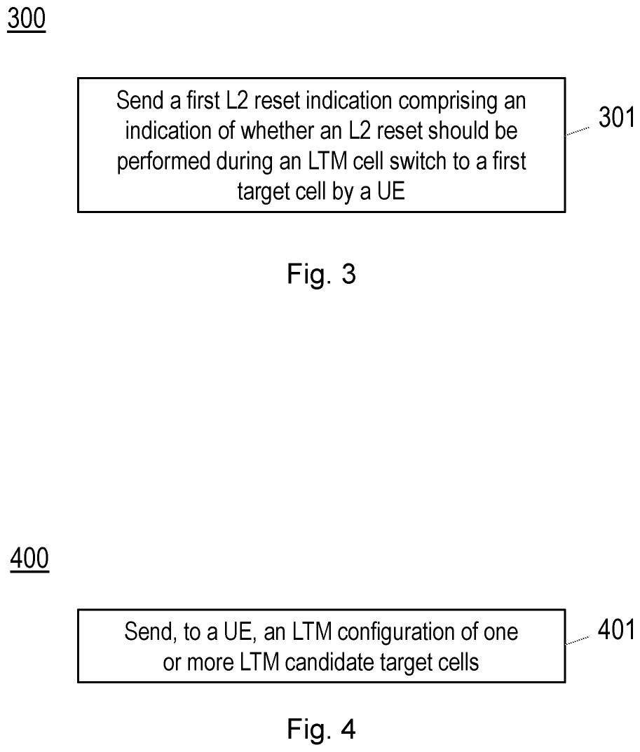

FIG. 3 is a flow chart illustrating a method 300 performed by a first network node in accordance with some embodiments. The first network node may be, for example, a source network node such as S-DU, a first target network node, or a second target network node. The first network node may be a DU.

The method 300 comprises, at step 301, sending a first L2 reset indication comprising an indication of whether an L2 reset should be performed during an LTM cell switch to a first target cell by a UE. The first L2 reset indication may be sent to the UE. The first L2 reset indication may be sent to a third network node, e.g., a Central Unit.

The first L2 reset indication may be sent in an MAC CE. The MAC CE may further comprise LTM configuration of one or more LTM candidate target cells, where the one or more LTM candidate target cells comprises the first target cell. The first L2 reset indication may be comprised in an LTM configuration of one or more LTM candidate target cells, where the one or more LTM candidate target cells comprises the first target cell. The first L2 reset indication may be sent in the same L2 signalling as an LTM configuration of one or more LTM candidate target cells, or the first L2 reset indication may be sent in different L2 signalling to an LTM configuration of one or more LTM candidate target cells.

An L2 reset may comprise a reset of one or more L2 protocols of a plurality of L2 protocols. An L2 reset may comprise a reset of only one or more L2 protocols of a plurality of L2 protocols. An L2 reset may comprise one or more of: a full L2 reset; a partial L2 reset; a Medium Access Control, MAC, reset; a partial MAC reset; re-establishment; Radio Link Control, RLC, re-establishment; Packet Data Convergence Protocol, PDCP, re-establishment; data recovery; and PDCP data recovery; of one or more L2 protocol sublayers and/or one or more L2 protocol entities configured for a UE.

The UE may be operating in a cell group controlled by the first network node. The UE may be operating in dual connectivity with a MCG comprising a PCell, and at least a SCG comprising a PSCell, where the serving cell comprises the PCell and the PSCell.

FIG. 4 is a flow chart illustrating a method 400 performed by a third network node in accordance with some embodiments. The third network node is serving a UE. The third network node may be a CU or a DU.

The method 400 comprises, at step 401, sending, to the UE, an LTM configuration of one or more LTM candidate target cells, where the one or more LTM candidate target cells comprise a first target cell. The LTM configuration may be comprised in an RRC Reconfiguration message.

The method 400 may comprise sending, to the UE, a first L2 reset indication comprising an indication of whether an L2 reset should be performed during a LTM cell switch to a first target cell. The first L2 indication may be sent with the LTM configuration of the one or more LTM candidate target cells. The first L2 reset indication may be sent in the same L2 signalling as the LTM configuration of one or more candidate target cells. The first L2 reset indication may be comprised in the LTM configuration. Alternatively, the first L2 reset indication may be sent in different L2 signalling to the LTM configuration of one or more candidate target cells.

An L2 reset may comprise a reset of one or more L2 protocols of a plurality of L2 protocols. An L2 reset may comprise a reset of only one or more L2 protocols of a plurality of L2 protocols. An L2 reset may comprise one or more of: a full L2 reset; a partial L2 reset; an MAC reset; a partial MAC reset; re-establishment; RLC re-establishment; PDCP re-establishment; data recovery; and PDCP data recovery; of one or more L2 protocol sublayers and/or one or more L2 protocol entities configured for the UE.

The first L2 reset indication may comprise a list of one or more cells, where an L2 reset should not be performed if the UE is in one of the listed cells when the UE executes a LTM cell switch.

The first L2 indication may be received from a first network node (e.g., the first network node of the method 300 of FIG. 3). The first network node may be a DU.

The first L2 indication may be received from a first target network node. The first target network node may be a candidate DU.

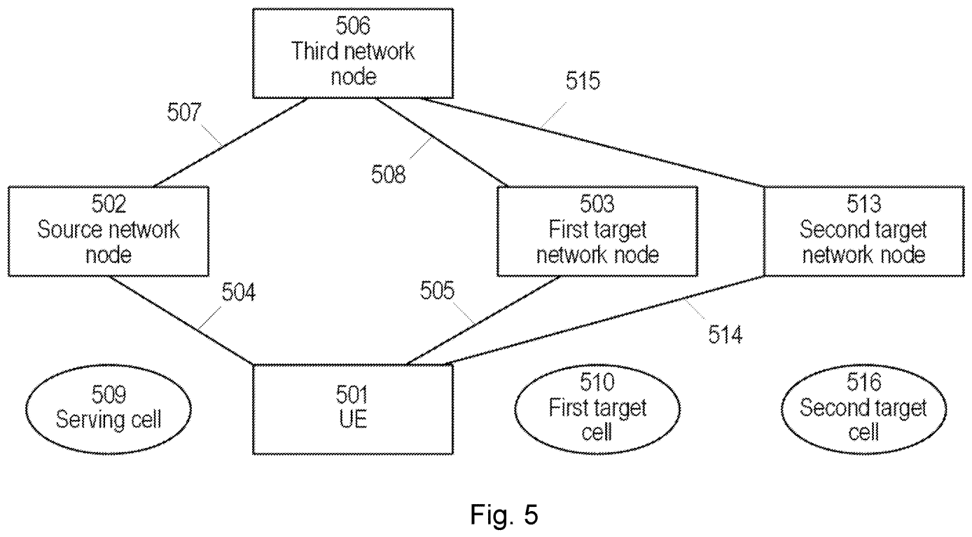

FIG. 5 illustrates a system structure including the entities involved in the techniques described herein. The User Equipment (UE) 501 is a wireless terminal, such as a cellular smartphone, sometimes connected to the source network node 502 over a wireless interface 504 and sometimes connected to a first target network node 503, to which the UE 501 is connected over a wireless interface 505. In some cases, the UE 501 is connected to a second target network node 513, to which the UE 501 is connected over a wireless interface 514.

In the context of a mobility procedure, such as a LTM cell switch procedure, for the UE, the source network node 502, sometimes also referred to as the serving network node, controls a serving cell 509 (which, in the context of a mobility procedure for the UE, can be referred to as the source cell) and the first target network node 503 controls a first target cell 510. In the context of a mobility procedure for the UE, a second target cell 516 may alternatively be controlled by the first target network node 503, a second target network node 513 or the source network node 502. Each of source network node 502 and the first target network node 503 may be a base station such as, e.g. a gNB, or, e.g. in case of a distributed CU/DU Radio Access Network (RAN) architecture, a distributed unit, sometimes known as either gNB-DU or DU. Hence the source network node 502 corresponds to a source DU, sometimes also known as serving DU (S-DU), and the first target network node 503 corresponds to a target DU (T-DU). Both the source network node 502 and the target network node 503 are connected to a third network node 506, which can be referred to as the serving network node.

Further, the third network node 506 may, e.g. in case of a distributed CU/DU RAN architecture, be a central unit, CU, sometimes referred to as the serving CU, known as either a gNB-CU, CU, gNB-CU-Control Plane (gNB-CU-CP) or gNB-CU-User Plane (gNB-CU-UP), or a core network node such as an User Plane Function, UPF or an Access and Mobility management Function (AMF).

The second target network node 513 may be a base station such as e.g. a gNB, or, e.g. in case of a distributed CU/DU RAN architecture, a distributed unit, sometimes known as either gNB-DU or DU, (second) target DU, (second) T-DU.

In particular embodiments, methods for operating a UE are presented. In these methods, the UE is configured with a serving cell and the UE receives a LTM configuration including one or more LTM candidate target cells. The UE further obtains an L2 reset indication (i.e. an indication on whether to perform a L2 reset or not during the execution of the LTM cell switch), and based on the L2 reset indication determines whether or not to perform a L2 reset during the execution of the LTM cell switch.

In some embodiments, the UE receives the LTM configuration of a LTM candidate target cell and further receives a lower layer command for executing an LTM cell switch to a target cell. The UE further obtains a L2 reset indication, and in response performs an LTM cell switch to the target cell. Based on the obtained L2 reset indication, the UE determines whether to perform L2 reset or not during the LTM cell switch.

In some embodiments, the UE receives a LTM configuration of a LTM candidate target cell for a first target cell, and a LTM configuration of a LTM candidate target cell for a second target cell. The UE further receives a first lower layer command for executing an LTM cell switch to the first target cell, and the UE further obtains an L2 reset indication. In response the UE performs an LTM cell switch to the first target cell, and based on the obtained L2 reset indication the UE determines whether or not to perform L2 reset during the LTM cell switch. Then, while in the first target cell, the UE receives a second lower layer command for executing an LTM cell switch to the second target cell, and further obtains an L2 reset indication. Then, in response the UE performs an LTM cell switch to the second target cell, and based on the obtained L2 reset indication the UE determines whether or not to perform L2 reset during the LTM cell switch.

The L2 reset indication (i.e. an indication on whether to perform a L2 reset or not during the execution of the LTM cell switch) can be indication on whether or not to perform a reset, partial (L2) reset, re-establishment or data recovery of at least one of the L2 protocol sublayers or L2 protocol entities configured for the UE.

The L2 reset indication can be one or a combination of indications on whether or not to perform a partial L2 reset, a MAC reset, a partial MAC reset, a RLC re-establishment, a PDCP data recovery, a PDCP re-establishment. That is, the L2 reset indication can separately indicate whether a reset/recovery/re-establishment is to be performed per Layer 2 protocol layer.

In some examples, the L2 reset indication can be is encoded as a list with corresponding fields for MAC, RLC and PDCP, as follows:

| | |
|---|---|
| L2-ResetIndicator ::= | SEQUENCE { |
| resetMAC | ENUMERATED {true} OPTIONAL, -- Need N |
| partialResetMAC | ENUMERATED {true} OPTIONAL, -- Need N |
| reestablishRLC | ENUMERATED {true} OPTIONAL, -- Need N |
| recoverPDCP | ENUMERATED {true} OPTIONAL, -- Need N |
| reestablishPDCP | ENUMERATED {true} OPTIONAL, -- Need N |

}

A benefit of having individual reset indications per protocol layer (MAC, RLC, PDCP) is that it allows the network to flexibly control whether reset/reestablishment is performed per protocol layer. For instance, the network deployment may be such that for a particular LTM cell switch procedure, only the MAC entity needs to be relocated from one network node, hardware or software entity to another, whereas the RLC and PDCP protocol entities may not need to be moved, e.g. if their current node, hardware or software entity can serve both source and target cell. In this case, the network would indicate only MAC reset to the UE, and since RLC re-establishment is then not performed, the amount of data lost or requiring retransmission on PDCP can be reduced compared to RLC re-establishment, where the RLC buffers are flushed.

On the other hand, if the RLC entity also needs to be moved on the network side from a source to a target node, hardware or software entity, the network would indicate MAC reset, RLC re-establishment and PDCP recovery in order to trigger also RLC re-establishment and PDCP data recovery to ensure data is properly handled towards the UE during the switch from source to target node, hardware or software entity.

In some embodiments, the L2 reset indication is indicated for a MAC entity, cell group, L2 protocol entity, radio bearer, data radio bearer, signalling radio bearer or RLC bearer.

In one example the L2-ResetIndicator is added per RLC-BearerConfig in CellGroupConfig, assuming the LTM candidate target cell configuration is a CellGroupConfig. This means that the L2 reset actions can be controlled per Data Radio Bearer (DRB). Here, with the L2-ResetIndicator the network does not have the possibility to signal the L2 reset separately for different entities, but when this indication is included, it means that at least the MAC and RLC should be reset for that RLC bearer.

| | |
|---|---|
| RLC-BearerConfig ::= | SEQUENCE { |
| logicalChannelIdentity | LogicalChannelIdentity, |
| servedRadioBearer | CHOICE { |

| | |
|---|---|
| srb-Identity | SRB-Identity, |
| drb-Identity | DRB-Identity |
| } | OPTIONAL, -- Cond LCH-SetupOnly |

| | | |
|---|---|---|
| reestablishRLC | ENUMERATED {true} | OPTIONAL, -- Need N |
| rlc-Config | RLC-Config | OPTIONAL, -- Cond LCH- |

Setup

| | | |
|---|---|---|
| mac-LogicalChannelConfig | LogicalChannelConfig | OPTIONAL, --Cond LCH- |

```
Setup
  ...,
    [[
```

| | | |
|---|---|---|
| rlc-Config-v1610 | RLC-Config-v1610 | OPTIONAL -- Need R |

```
  ]],
    [[
```

| | | |
|---|---|---|
| rlc-Config-v1700 | RLC-Config-v1700 | OPTIONAL, -- Need R |

| | |
|---|---|
| logicalChannelIdentityExt-r17 | LogicalChannelIdentityExt-r17 |

OPTIONAL, -- Cond LCH-SetupModMRB

| | |
|---|---|
| multicastRLC-BearerConfig-r17 | MulticastRLC-BearerConfig-r17 |

OPTIONAL, -- Cond LCH-SetupOnlyMRB

| | | |
|---|---|---|
| servedRadioBearerSRB4-r17 | SRB-Identity-v1700 | OPTIONAL -- Need N |

```
  ]]
    [[
```

| | | |
|---|---|---|
| Layer2reset | L2-ResetIndicator | OPTIONAL, -- Need N |

]]
}

In another example, the L2-ResetIndicator can be added per CellGroupConfig, assuming the LTM candidate target cell configuration is a CellGroupConfig. This means that the L2 reset actions can be controlled per MAC entity.

A benefit of placing the L2-ResetIndicator in RLC-BearerConfig is that it gives more granularity for indicating whether L2 reset is to be performed or not, and to what extent. For instance, the MAC, RLC and PDCP entities of different DRBs may be terminated in different network nodes. Upon a LTM cell switch, there may thus be a need to reestablish RLC for some DRBs, but not for others.

A benefit of placing the L2-ResetIndicator in CellGroupConfig is less signalling overhead, but a drawback is that it means all DRBs will be treated the same during LTM cell switch.

In some embodiments, the L2 reset indication can be indicated for a set of MAC entities, cell groups, L2 protocol entities, radio bearers, data radio bearers, signalling radio bearers or RLC bearers.

In some embodiments, the L2 reset indication can indicate whether the LTM cell switch is performed to a target cell that is controlled by a different network node than the source network node. Alternatively, the L2 reset indication can indicate inter-network node or intra-network node, for example an intra-DU LTM cell switch or inter-DU LTM cell switch.

In some embodiments, the L2 reset indication is obtained in the configuration of a LTM candidate target cell.

In some embodiments, the L2 reset indication is obtained in lower layer signalling, such as a MAC CE. In one implementation, the L2 reset indication is contained in the same lower layer signalling as that including the LTM cell switch information, such as in a LTM cell switch MAC CE. In one example, upon reception of the lower layer signalling that includes the LTM cell switch information, the UE performs the L2 reset during the LTM cell switch. In another implementation, the L2 reset indication is contained in separate lower layer signalling (such as a separate MAC CE).

A benefit in the method based on lower layer signalling is that each S-DU is aware of its own cells configured as LTM candidate(s) for a given UE. In other words, when the S-DU determines to trigger for the UE an LTM cell switch to one of its own cells, it does not include a L2 reset indication. However, when the S-DU determines to trigger for the UE an LTM cell switch to a cell which is not one of its own cells, it includes a L2 reset indication (in that case each candidate DU may want to know in advance that a L2 reset is to be triggered, but it also knows that it the UE is coming from another DU).

In some embodiments, a L2 reset indication received in lower layer signalling (e.g. in a MAC CE) overrides the indication received within a LTM candidate target cell.

In alternative embodiments, a L2 reset indication received in a LTM candidate target cell overrides the indication received within lower layer signalling (e.g. in a MAC CE).

In some embodiments, the L2 reset indication is defined per “incoming cell” (or a source cell) when LTM cell switch is performed. The “incoming cell” may correspond to the cell in which the UE receives the lower layer command for LTM cell switch. In one example, the UE receives a list of one or more possible incoming cell(s) (source cell(s)) from which a L2 reset is not required if the UE comes (switches) from them. Thus, when the UE is in one of these cells, and performs a LTM cell switch, the UE determines to not perform L2 reset. In one example, the LTM candidate target cell configuration, e.g., associated to a candidate cell C, indicates one or more cells (e.g. cell B) from which the UE may come from in an LTM execution to the cell C without the need to perform a L2 reset or perform only a partial L2 reset (e.g. by indicating one or more cell identities or LTM configuration identities associated to the source cells).

For example, when the UE is in cell B and receives the lower layer command for LTM (e.g. MAC CE) cell switch to cell C, the UE performs the LTM cell switch procedure from cell B to cell C without a L2 reset. In one option, the Candidate DU, which configures cell C as a candidate cell for LTM upon a request from the CU and/or Source DU, for that UE, is aware of other one(s) of its cells which may also be considered as candidate cells for LTM for the same UE (e.g. Candidate cell B), and may set these cells as the source cells from which the UE may come from to cell C without the need to a L2 reset. As another example, when the UE is in cell B and receives the lower layer command for LTM (e.g. MAC CE) to cell A, the UE performs the procedure with a L2 reset (as cell A is not listed as a cell from which the UE comes from without a L2 reset).

In embodiments related embodiments where the L2 reset indication is obtained in the configuration of a LTM candidate target cell, obtained in lower layer signalling, and/or is defined per incoming cell, when the UE in a source cell receives the lower layer command for executing LTM cell switch (e.g. MAC CE) to a target cell; when that source cell is not associated in the LTM target cell configuration, as a cell for which L2 reset is not to be performed, the UE performs a L2 reset. In terms of signalling, the UE may receive to indicate the actions described above there may be different options.

In an option (a), the UE receives an RRC Reconfiguration message including a configuration for an LTM candidate target cell (denoted below LTM-CandidateToAddMod), including an indication or one of more source cells. Thus, the UE receives, per LTM candidate cell, an indication of one or more source cells from which the UE may come from in an LTM cell switch, to the LTM candidate target cell, without performing L2 reset. Thus, when the UE receives the lower layer signalling for LTM cell switch (e.g. MAC CE) to the LTM candidate target cell while the UE is in one of these indicated source cells, the UE performs cell switch without a L2 reset. When the UE receives the lower layer signalling for LTM cell switch (e.g. MAC CE) to the LTM candidate target cell while the UE is in a cell which is not one of these indicated source cells, the UE performs cell switch with a L2 reset.

In one embodiment of option (a), the indication of one or more source cells (denoted in the signalling below as sourceCellNoL2reset-List) is included as a field/parameter/IE in the configuration for the LTM candidate target cell (denoted below LTM-CandidateToAddMod). That is not necessarily nested within the actual target cell configuration the UE applies or uses/switches to upon cell switch for LTM, denoted below by candConfig-r18 of OCTET STRING (CONTAINING CellGroupConfig).

LTM-CandidateToAddModList-r18 ::= SEQUENCE (SIZE (1.. maxNrofCandCells-r18))
OF
LTM-CandidateToAddMod-r18

| | |
|---|---|
| LTM-CandidateToAddMod-r18 ::= | SEQUENCE { |
| candId-r18 | Cand-LTM-Id-r18 |

[...]

| | |
|---|---|
| candConfig-r18 | OCTET STRING (CONTAINING CellGroupConfig) |

[...]
// List of source cells from which the UE may come via LTM cell switch
without a L2 reset for this candidate cell

| | |
|---|---|
| sourceCellNoL2reset-List | SEQUENCE (SIZE (1..K)) OF SourceCellNoL2reset |

}

| | |
|---|---|
| Cand-LTM-Id-r18 ::= | INTEGER (1.. maxNrofCandCells-r18) |

In another embodiment of option (a), the indication of one or more source cells (denoted in the signalling below as sourceCellNoL2reset) is included as a field/parameter/IE in the configuration for the LTM candidate target cell (denoted below LTM-CandidateToAddMod) and within the actual target cell configuration the UE applies or uses/switches to upon cell switch for LTM. For example, the sourceCellNoL2reset-List is included within the IE for the candConfig-r18, for example, within the OCTET STRING (CONTAINING CellGroupConfig) or, within the OCTET STRING (CONTAINING RRCReconfiguration).

In an embodiment of option (a), the indication or one of more source cells is provided to the UE as a list of cell identifiers. For example, that indication may correspond to one or more of LTM configuration identifiers (one or more instances of an IE that indicates a configuration ID for LTM e.g., the IE Cand-LTM-Id-r18 shown above), each pointing to an LTM candidate target configuration. That is possible because these one or more source cells may be candidate cells for LTM, so that they are configured in the UE for LTM, and have their own LTM configuration ID. For example, the UE is configured for LTM with candidate cell A, cell B and cell C, each of them having a configuration ID, e.g.: cell A→Cand-LTM-Id-r18=x1, cell B→Cand-LTM-Id-r18=x2, and cell C→→Cand-LTM-Id-r18=x3. Then, for each candidate cell for the UE, the source cells from which the UE may come from without the need for L2 reset is indicated as follows:
Cell A:
   Cand-LTM-Id-r18=x1
Cell B:
   Cand-LTM-Id-r18=x2
   sourceCellNoL2reset-List=x3
Cell C:
   Cand-LTM-Id-r18=x3
   sourceCellNoL2reset-List=x2

As another example, the indication or one of more source cells provided to the UE as a list of cell identifiers may correspond to one or more Physical Cell Identities (PCIs). The UE may determine the SSB frequency (e.g. SSB Absolute Radio Frequency Channel Number (ARFCN)) for the indicated PCI(s) by assuming it is the same SSB frequency for the associated target candidate. For example, that may correspond to one or more instances of the CellIdentity IE(s), as defined in TS 38.331, or any other cell identity used to unambiguously identify a cell within a Public Land Mobile Network (PLMN).

In an option (b), the UE receives a RRC Reconfiguration message including configurations for one or more LTM candidate target cell(s) (denoted below LTM-CandidateToAddMod), and an indication of at least one set (or group) of cells, with a group comprising candidate cell(s) the UE is configured with for LTM. The indication of the at least one set of cells is received by the UE, for example, as a cell set 1 [cell A, cell X, cell Y], cell set 2 [cell B, cell C] to indicate that, when the UE performs a cell switch for LTM within a set, the UE does not perform L2 reset. Or, in other words, if the UE is in a serving cell and receives a lower layer command for LTM cell switch to a cell which is not within the same set, the UE performs a L2 reset when it performs the cell switch for LTM.

For example, if the UE is in cell A and receives a lower layer command for LTM cell switch for cell X or cell Y, the UE does not perform L2 reset. However, if the UE is in cell A and receives a lower layer command for LTM cell switch for cell C, the UE performs L2 reset.

As in option (a), a set (or group) may be indicated as one or more PCI(s), cell identifiers or LTM configuration identifiers (as these are also candidate cells). In the example below, the sets are shown as LTM candidate identifiers.

LTM-CandidateToAddModList-r18 ::= SEQUENCE (SIZE (1.. maxNrofCandCells-r18))
OF
LTM-CandidateToAddMod-r18

| | |
|---|---|
| sourceCellNoL2reset-Lists | SEQUENCE (SIZE (1..K)) OF SourceCellNoL2reset-List |
| SourceCellNoL2reset-List | SEQUENCE (SIZE (1..K)) OF Cand-LTM-Id-r18 |

| | |
|---|---|
| LTM-CandidateToAddMod-r18 ::= | SEQUENCE { |
| candId-r18 | Cand-LTM-Id-r18 |

[...]

| | |
|---|---|
| candConfig-r18 | OCTET STRING (CONTAINING CellGroupConfig) |

[...]
// List of source cells from which the UE may come via LTM cell switch
without a L2 reset for this candidate cell
}

| | |
|---|---|
| Cand-LTM-Id-r18 ::= | INTEGER (1.. maxNrofCandCells-r18) |

One benefit of option (b) is that the signalling is reduced compared to option (a), as most likely, if there is no need to perform a L2 reset from cell A to cell B, there is no need to perform L2 reset from cell B to cell A. Therefore with this signalling there is no need to indicate in or with the configuration of cell A the ‘no L2 reset from cell B’, and indicate in or with the configuration of cell B the ‘no L2 reset from cell A’. One alternative to reduce the signalling in option (a) is for the UE to receive an indication that no L2 reset is needed in the LTM cell switch from A to B (e.g. an indication in the configuration of the LTM candidate target cell B), and the UE interpreting, in addition, that no L2 reset is needed in the LTM cell switch from B to A, even though the indication in the configuration of the LTM candidate target cell A was absent, to save signalling.

One overall advantage of the method based on RRC signalling is that this might be transparent to a Serving/Source DU which triggers LTM cell switch, as the RRC signalling goes directly to the UE. In the option where the source cell(s) or sets are indicated within the candidate configuration to apply (e.g. CellGroupconfig), that is even transparent to the CU. In the option where the source cell(s) or sets are indicated outside the candidate's CellGroupConfig, the CU may need to be involved as it generates the final message the UE needs to apply or switch to. In addition, in principle, it does not need to be visible as that is more a deployment property. However, it might be argued that to some extent the deployment is exposed to the UE, as the UE might figure out which candidate cells are grouped in the same DU. An alternative is to rely on a more dynamic signalling via a lower layer signalling, e.g. MAC CE, as presented as follows.

Thus, in some embodiments, the L2 reset indication is obtained as a combination of a LTM candidate target cell and in a lower layer signalling (e.g. a MAC CE). In one approach, when one of these indications indicates to perform L2 reset and the other one indicates ‘no L2 reset’, the UE performs L2 reset. In another approach, when one of these indications indicates to perform L2 reset and the other one indicates ‘no L2 reset’, the UE does not perform L2 reset. In another approach, the UE always performs L2 reset, except when both of these indications indicate ‘no L2 reset’. In yet another approach, the UE follows the indication of the lower layer signalling, regardless of whether the indication in the LTM candidate target cell indicates L2 reset or no L2 reset.

In some embodiments, wherein the first target cell is controlled by a first target network node. In some embodiments, the second target cell is controlled by a source target network node. In some embodiments, the second target cell is controlled by a first target network node. In some embodiments, the second target cell is controlled by a second target network node.

In some embodiments, the L2 reset indication is received from the source network node. In alternative embodiments, the L2 reset indication is received from the third network node. In alternative embodiments, the L2 reset indication is received from the first target network node.

This disclosure also presents methods performed by a source network node (e.g. a source DU), such as a source gNB, a source DU, serving DU or a source CU. The source network node is to handle a L2 reset indication for a UE configured with a serving cell and an LTM configuration including one or more LTM candidate target cells.

In these methods, the L2 reset indication can be transmitted to the UE.

In these methods, the L2 reset indication can be included in lower layer signalling, e.g., a MAC CE. In one approach, the L2 reset indication can be included in the same lower layer signalling (e.g., MAC CE) as that used to indicate the executing of the LTM cell switch procedure. In another approach, the L2 reset indication can be included in a separate lower layer signal, e.g., MAC CE, that is different from the one used to indicate the execution of the LTM cell switch.

In some embodiments, if the L2 reset indication is included in a lower layer signalling that is different from the one used to indicate the execution of the LTM cell switch, the source network node sends the lower layer signalling for the L2 reset and the lower layer signal for the LTM cell switch in the same Protocol Data Unit (PDU) message. In one approach, the lower layer signalling for the L2 reset indication is added in the PDU message before the lower layer signalling for the LTM cell switch. In another approach, the lower layer signalling for the L2 reset indication is added in the PDU message after the lower layer signalling for the LTM cell switch. In yet another approach, the UE always executes/applies the lower layer signalling for the L2 reset indication first, and then executes/applies the lower layer signalling for the LTM cell switch. In another approach, the UE always executes/applies the lower layer signalling for the LTM cell switch first, and then executes/applies the lower layer signalling for the L2 reset indication.

In some embodiments, the source network node determines a value of the L2 reset indication. In one approach, the source network node determines the value of the L2 reset indication based on which network node that controls a target cell during execution of a LTM cell switch for a UE to that target cell.

This disclosure also presents methods performed by a third network node (CU) (or serving network node), such as a (serving) Central Unit (CU), (serving) gNB-CU. The third network node is to handle an L2 reset indication for a UE configured with a serving cell and an LTM configuration including one or more LTM candidate target cells.

In some embodiments, the L2 reset indication is included in the configuration of a LTM candidate target cell.

In some embodiments, the L2 reset indication is transmitted to the UE. In some embodiments, the L2 reset indication is transmitted to the first target network node. In some embodiments, the L2 reset indication is transmitted to the source network node.

In some embodiments, the CU sends a request to any one or more of the source network node, the first target network node, and the second target network node to provide an L2 reset indication for a LTM candidate target cell(s) configured by one of these network nodes. In one approach, the request is explicit, meaning that that the CU uses a specific field/structure/IE to request this information from the source network node, first target network node, and/or second target network node. In another approach, the request is implicit, meaning that source network node, first target network node, and/or second target network node provide the CU with this information every time that a request to configure a new LTM candidate target cell is received.

In some embodiments, the third network node determines a value of the L2 reset indication. In one approach, the third network node determines the value of the L2 reset indication based on which network node that controls a target cell during execution of a LTM cell switch for a UE to that target cell.

This disclosure also presents methods performed by a first target network node (target DU), such as a first target gNB, a first target DU, or a first target CU. The first target network node is to handle an L2 reset indication for a UE configured with a serving cell and an LTM configuration including one or more LTM candidate target cells.

In some embodiments, the L2 reset indication is transmitted to the UE.

In some embodiments, the L2 reset indication is included in a lower layer signalling (e.g., MAC CE). In one approach, the L2 reset indication is included in the same lower layer signalling (e.g., MAC CE) to executing the LTM cell switch to the second target network node. In one example the L2 reset indication is sent only after the UE has received a lower layer command (e.g., MAC CE) to execute the LTM cell switch to the first target network node by the source network node and the LTM cell switch procedure has been successfully completed. In an alternative approach, the L2 reset indication can be included in a separate lower layer signal, e.g., MAC CE, that is different from the one used to indicate the execution of the LTM cell switch.

In embodiments wherein the L2 reset indication is included in lower layer signalling, if the L2 reset indication is included in a lower layer signalling that is different from the one used to indicate the execution of the LTM cell switch, the first target network node can send the lower layer signalling for the L2 reset indication and the lower layer signal for the LTM cell switch in the same PDU message. In one approach, the lower layer signalling for the L2 reset indication can be added in the PDU message before the lower layer signalling for the LTM cell switch. In an alternative approach, the lower layer signalling for the L2 reset indication can be added in the PDU message after the lower layer signalling for the LTM cell switch. In yet another approach, the UE can always execute/apply the lower layer signalling for the L2 reset indication first, and then execute/apply the lower layer signalling for the LTM cell switch. In yet another approach, the UE can always execute/apply the lower layer signalling for the LTM cell switch first, and then execute/apply the lower layer signalling for the L2 reset indication.

In some embodiments, the L2 reset indication can be included in the configuration of a LTM candidate target cell. In some embodiments, the L2 reset indication can be transmitted to the third network node. In some embodiments, the L2 reset indication can be transmitted to the source network node.

In some embodiments, the first network node determines a value of the L2 reset indication. In one approach, the first network node can determine the value of the L2 reset indication based on which network node that controls a target cell during execution of a LTM cell switch for a UE to that target cell.

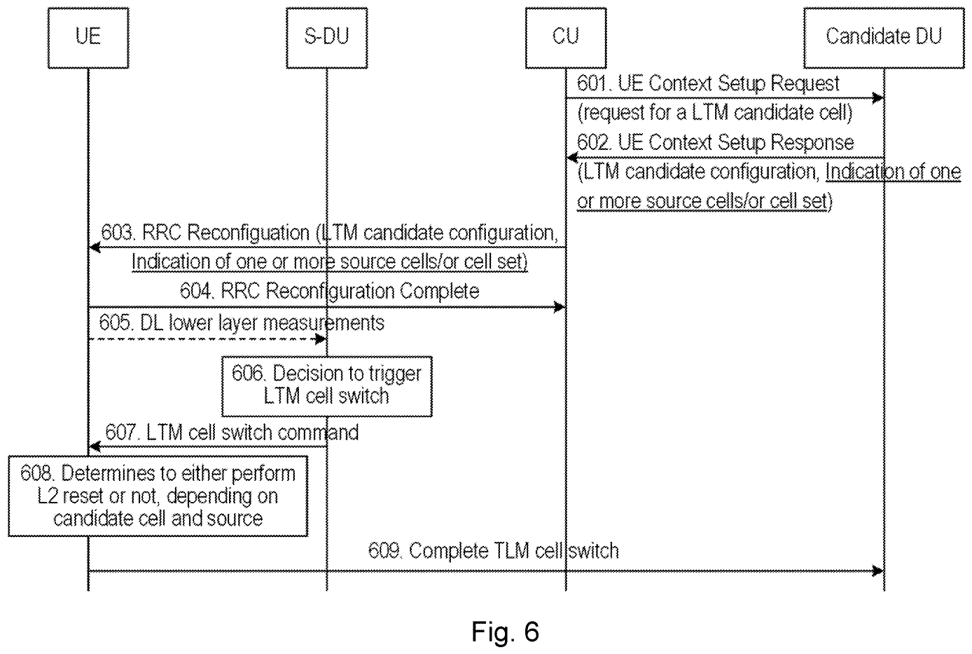

FIG. 6 below illustrates one exemplary implementation of the techniques described herein. FIG. 6 is an example of a message sequence chart in one example. FIG. 6 is a signalling diagram illustrating the signalling by a UE, a source network node (S-DU), a third network node (e.g., a CU) and a first target network node (e.g., a Candidate DU). In this example, the CU includes a L2 reset indication in the configuration of a LTM candidate target cell.

Referring to FIG. 6, the main steps in this example are as follows.

Step 601. The CU initiates configuration of a candidate target cell for L1/L2 mobility and transmits a UE CONTEXT SETUP REQUEST message to the candidate DU (first target network node) to create a UE context and to request a configuration of at least one LTM candidate target cell.

Step 602. The candidate DU responds with a UE CONTEXT SETUP RESPONSE message to the gNB-CU. The message includes a configuration of at least one LTM candidate target cell and at least one L2 reset indication. In this example, the L2 reset indication includes one or more source cells or a set of source cells, from which L2 reset is not required if the UE comes from one of them during LTM cell switch towards the particular candidate target cell.

Step 603. The CU transmits a DL RRC MESSAGE TRANSFER to the serving DU (source network node) including an RRCReconfiguration message, including a configuration of at least one LTM candidate target cell and the at least one L2 reset indication. The S-DU forwards the RRCReconfiguration message to the UE.

Step 604. The UE stores the configuration of at least one LTM candidate target cell and the at least one L2 reset indication and transmits a RRCReconfigurationComplete message to the serving DU. The serving DU transmits an UL RRC MESSAGE TRANSFER message to the CU to convey the received RRCReconfigurationComplete message.

Step 605. The UE performs L1 measurements on at least on one LTM candidate target cell and transmits lower layer (e.g. L1 or MAC) report(s) to the serving DU based on these measurements.

Step 606. The serving DU determines to trigger a LTM cell switch to a candidate cell for the UE.

Step 607. The serving DU transmits a lower layer command to the UE to request the execution of LTM cell switch. The message indicates a candidate cell.

Step 608. The UE executes the LTM cell switch to the indicated cell and determines whether or not to perform L2 reset during the switch according to the obtained one L2 reset indication. In this example, the UE determines whether to perform a L2 reset or not depending on the candidate cell and the source cell.

Step 609. The UE completes the LTM cell switch and may as a result transmit, to the candidate DU, an uplink signal in the target cell to confirm the successful execution of the LTM cell switch.

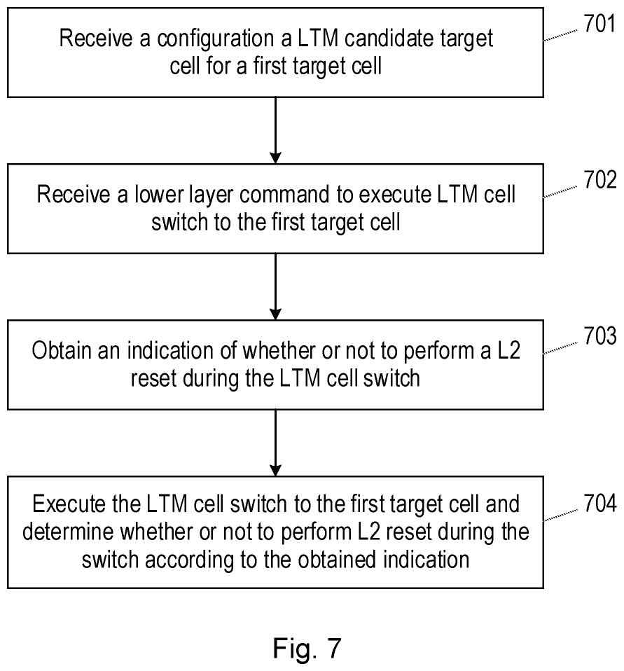

FIG. 7 is a flow chart with main operations performed by the UE.

FIG. 7 illustrates the main operations performed by a UE in one example of the techniques described herein. In this example, the UE performs a LTM cell switch to a first target cell and determines whether to perform L2 reset or not based on the obtained L2 reset indication.

Referring to FIG. 7, the main steps performed by the UE in this example are as follows:

Step 701. The UE receives a configuration a LTM candidate target cell for a first target cell.

Step 702. The UE receives a lower layer command to execute LTM cell switch to the first target cell.

Step 703. The UE obtains an L2 reset indication. In one example, the L2 reset indication is part of the configuration a LTM candidate target cell for a first target cell. In another example, the L2 reset indication is part of the lower layer command.

Step 704. The UE executes the LTM cell switch to the first target cell and determines whether or not to perform L2 reset during the switch according to the obtained L2 reset indication.

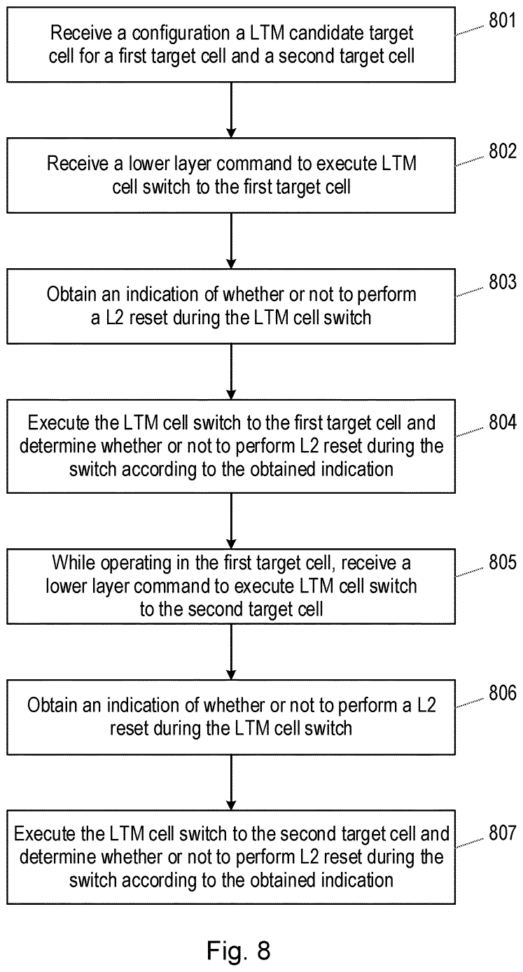

FIG. 8 is a flow chart with main steps performed by the UE in another example.

FIG. 8 illustrates the main operations performed by a UE in another example of the techniques described herein. In this example, the UE performs a LTM cell switch to a first target cell, followed by a LTM cell switch to a second target cell. During each LTM cell switch it determines whether to perform L2 reset or not based on the obtained L2 reset indication.

Referring to FIG. 8, the main steps performed by the UE in this example are as follows.

Step 801. The UE receives a configuration a LTM candidate target cell for a first target cell and a second target cell.

Step 802. The UE receives a lower layer command to execute LTM cell switch to the first target cell.

Step 803. The UE obtains a L2 reset indication. In one example, the L2 reset indication is part of the configuration a LTM candidate target cell for a first target cell. In another example, the L2 reset indication is part of the lower layer command.

Step 804. The UE executes the LTM cell switch to the first target cell and determines whether or not to perform L2 reset during the switch according to the obtained L2 reset indication.

Step 805. While the UE operates in the first target cell, it receives a lower layer command to execute LTM cell switch to the second target cell.

Step 806. The UE obtains a L2 reset indication. In one example, the L2 reset indication is part of the configuration a LTM candidate target cell for a first target cell. In another example, the L2 reset indication is part of the lower layer command.

Step 807. The UE executes the LTM cell switch to the second target cell and determines whether or not to perform L2 reset during the switch according to the obtained L2 reset indication.

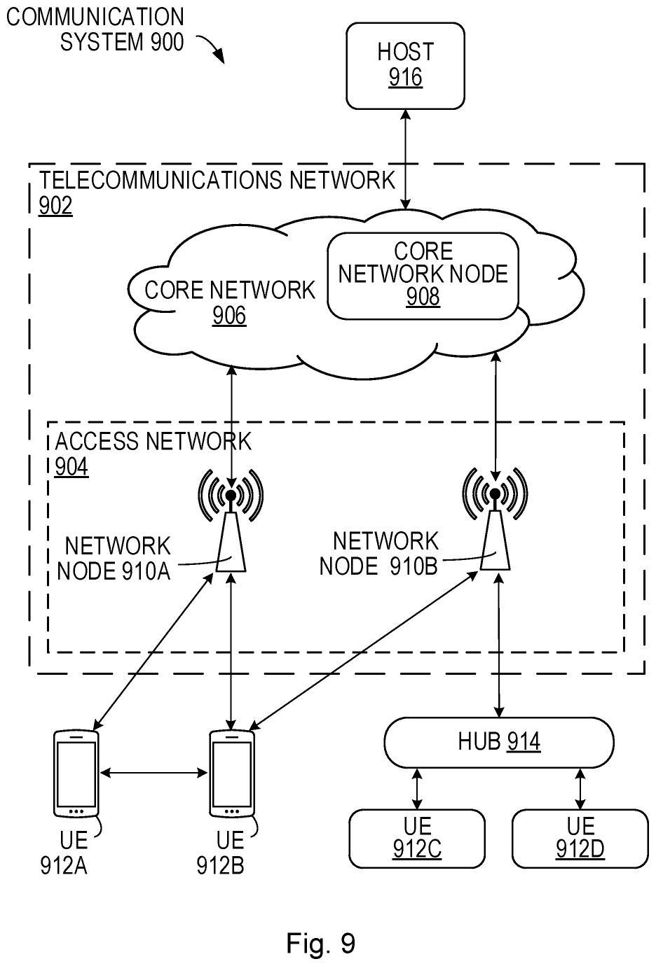

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as access network nodes 910a and 910b (one or more of which may be generally referred to as access network nodes 910), or any other similar 3rd Generation Partnership Project (3GPP) access node or non-3GPP access point. The access network nodes 910 facilitate direct or indirect connection of wireless devices (also referred to interchangeably herein as user equipment (UE)), such as by connecting UEs 912a, 912b, 912c, and 912d (one or more of which may be generally referred to as UEs 912) to the core network 906 over one or more wireless connections. The access network nodes 910 may be, for example, access points (APs) (e.g. radio access points), base stations (BSs) (e.g. radio base stations, Node Bs, evolved Node Bs (eNBs) and NR NodeBs (gNBs)).

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The wireless devices/UEs 912 may be any of a wide variety of communication devices, including wireless devices arranged, configured, and/or operable to communicate wirelessly with the network nodes 910 and other communication devices. Similarly, the access network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

The core network 906 includes one more core network nodes (e.g. core network node 908) that are structured with hardware and software components. Features of these components may be substantially similar to those described with respect to the wireless devices/UEs and access network nodes, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the wireless devices/UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 9, the hub 914 communicates with the access network 904 to facilitate indirect communication between one or more UEs (e.g. UE 912c and/or 912d) and access network nodes (e.g. access network node 910b). In some examples, the hub 914 may be a controller, router, a content source and analytics node, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g. UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

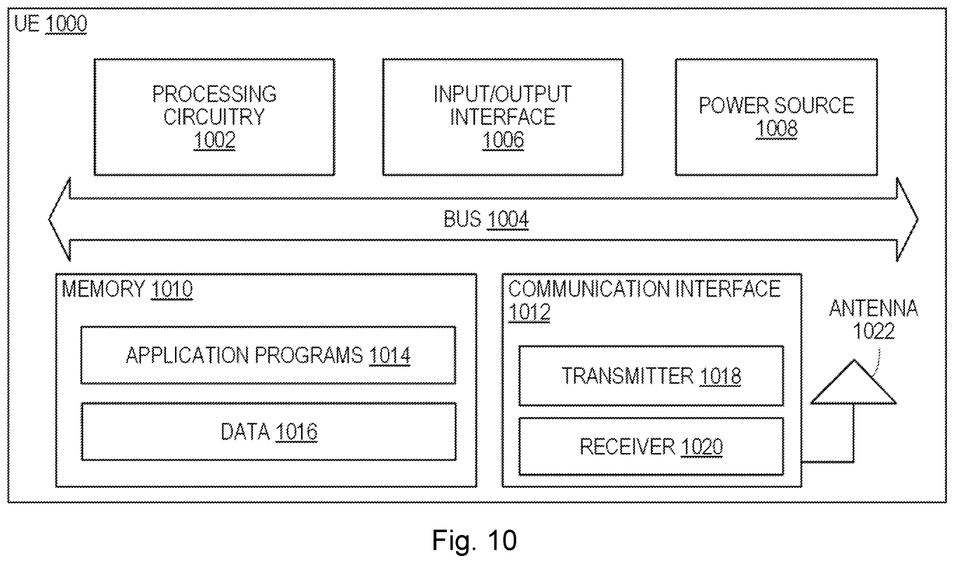

FIG. 10 shows a wireless device or UE 1000 in accordance with some embodiments.

As used herein, a UE refers to a device capable, configured, arranged and/or operable to communicate wirelessly with network nodes and/or other UEs. Examples of a wireless device/UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A wireless device/UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g. a smart sprinkler controller). Alternatively, a UE may represent a device that is not intended for sale to, or operation by, an end user but which may be associated with or operated for the benefit of a user (e.g. a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g. in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs). The processing circuitry 1002 may be operable to provide, either alone or in conjunction with other UE 1000 components, such as the memory 1010, to provide UE 1000 functionality. For example, the processing circuitry 1002 may be configured to cause the UE 1002 to perform the methods as described with reference to FIGS. 4 and 5 above.

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g. a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g. an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g. another UE or a network node in an access network). Each transceiver may include a transmitter 1018 and/or a receiver 1020 appropriate to provide network communications (e.g. optical, electrical, frequency allocations, and so forth). Moreover, the transmitter 1018 and receiver 1020 may be coupled to one or more antennas (e.g. antenna 1022) and may share circuit components, software or firmware, or alternatively be implemented separately.

In some embodiments, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g. once every 15 minutes if it reports the sensed temperature), random (e.g. to even out the load from reporting from several sensors), in response to a triggering event (e.g. when moisture is detected an alert is sent), in response to a request (e.g. a user initiated request), or a continuous stream (e.g. a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

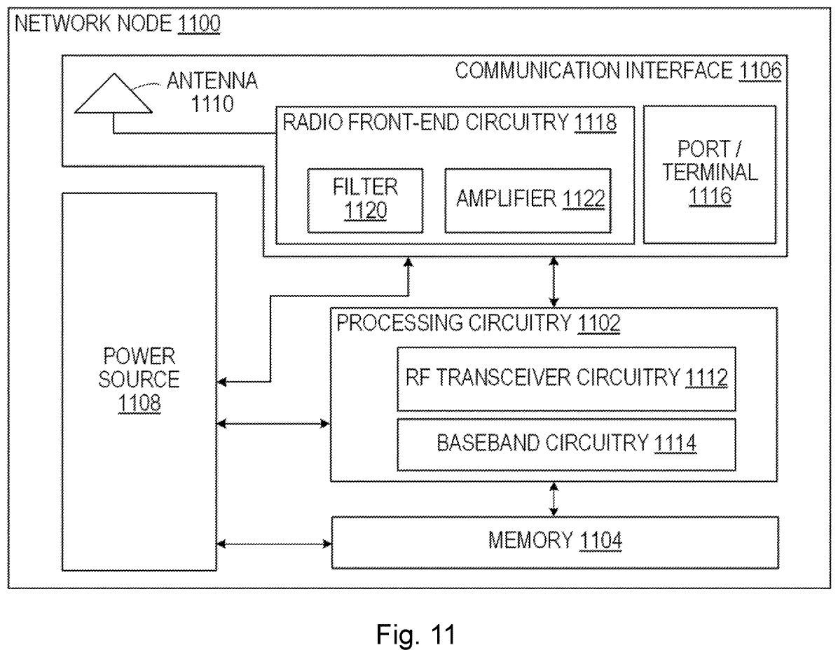

FIG. 11 shows a network node 1100 in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access network nodes such as access points (APs) (e.g. radio access points), base stations (BSs) (e.g. radio base stations, Node Bs, evolved Node Bs (eNBs) and NR NodeBs (gNBs)). Network node 1100 in FIG. 11 can represent any of the network nodes described herein, such as a source network node, a S-DU, a serving network node, a first target network node, a second target network node, a DU, a T-DU, a third network node, a CU, a gNB-CU, a gNB-CU-CP, a gNB-CU-UP, or a core network node such as a UPF or an AMF.

Base stations/DUs may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The network node 1100 includes processing circuitry 1102, a memory 1104, a communication interface 1106, and a power source 1108, and/or any other component, or any combination thereof. The network node 1100 may be composed of multiple physically separate components (e.g. a NodeB component and a RNC component, or a BTS component and a BSC component, etc.), which may each have their own respective components. In certain scenarios in which the network node 1100 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g. separate memory 1104 for different RATs) and some components may be reused (e.g. a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signalling and/or data between network nodes, the access network, the core network, and/or a UE. As illustrated, the communication interface 1106 comprises port(s)/terminal(s) 1116 to send and receive data, for example to and from a network over a wired connection.

In embodiments, the communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the access network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g. at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g. the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

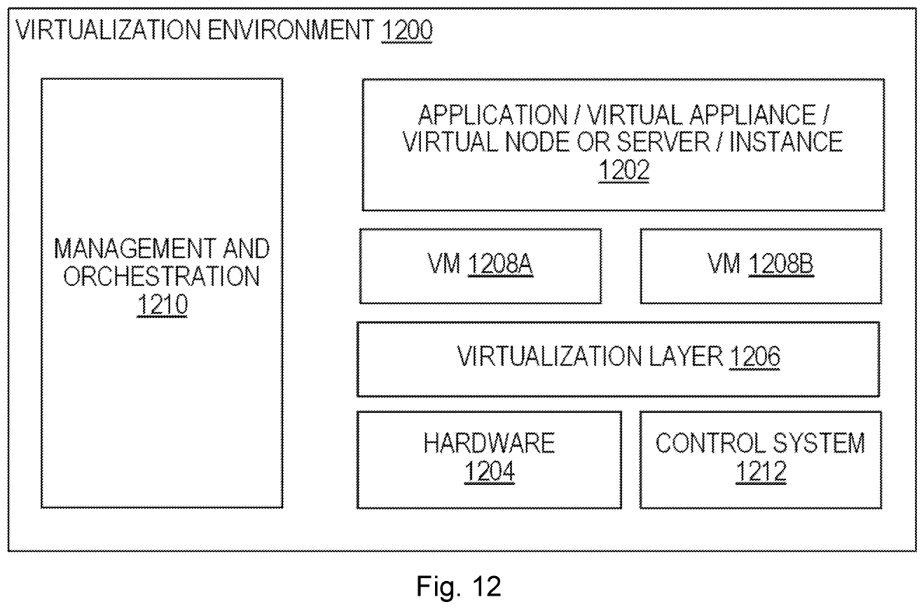

FIG. 12 is a block diagram illustrating a virtualization environment 1200 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as an access network node, a wireless device/UE, or a core network node. Further, in embodiments in which the virtual node does not require radio connectivity (e.g. a core network node), then the node may be entirely virtualized.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 1212 which may alternatively be used for communication between hardware nodes and radio units.

Although the computing devices described herein (e.g. UEs, network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

### EMBODIMENTS

### Group A Embodiments (UE)

1. A method performed by a user equipment, UE, the method comprising:
receiving (701) a Layer 1/Layer 2-triggered mobility, LTM, configuration of one or more LTM candidate target cells, wherein the one or more LTM candidate target cells comprise a first target cell;
receiving (702) a first command to execute an LTM cell switch to the first target cell;
obtaining (703) a first Layer 2, L2, reset indication comprising an indication of whether an L2 reset should be performed during the LTM cell switch to the first target cell; and
executing (704) the LTM cell switch to the first target cell according to the first command.
2. The method of embodiment 1, wherein the LTM configuration is received from a third network node.
3. The method of embodiment 2, wherein the third network node is a Centralized Unit, CU, serving the UE.
4. The method of any of embodiments 1-3, wherein the LTM configuration is comprised in a RRC Reconfiguration message.
5. The method of any of embodiments 1-4, wherein L2 reset comprises a reset of (only) one or more L2 protocols of a plurality of L2 protocols.
6. The method of any of embodiments 1-5, wherein L2 reset comprises one or more of: a full L2 reset; a partial L2 reset; a Medium Access Control, MAC, reset; a partial MAC reset; re-establishment; Radio Link Control, RLC, re-establishment; Packet Data Convergence Protocol, PDCP, re-establishment; data recovery; and PDCP data recovery; of one or more L2 protocol sublayers and/or one or more L2 protocol entities configured for the UE.
7. The method of any of embodiments 1-6, wherein the first command is comprised in a lower-layer signal.
8. The method of any of embodiments 1-7, wherein the first command is comprised in a Medium Access Control, MAC, Control Element, CE, or Downlink Control Information, DCI.
9. The method of any of embodiments 1-8, wherein the first command to execute the LTM cell switch to the first target cell is received from a first network node.
10. The method of any of embodiments 1-9, wherein obtaining (703) the first L2 reset indication comprises:
receiving the first L2 reset indication from a/the first network node.
11. The method of any of embodiments 9-10, wherein the first network node is a Distributed Unit, DU, serving the UE.
12. The method of any of embodiments 1-11, wherein the first L2 reset indication is received in a Medium Access Control, MAC, Control Element, CE.
13. The method of any of embodiments 1-12, wherein obtaining (703) the first L2 reset indication comprises:
receiving the first L2 reset indication in a same or different L2 signalling to the LTM configuration of the first target cell.
14. The method of any of embodiments 1-13, wherein the first L2 reset indication relates to one or more of: a Medium Access Control, MAC, entity, a cell group, an L2 protocol entity, a radio bearer, a data radio bearer, a signalling radio bearer or a Radio Link Control, RLC, bearer.
15. The method of any of embodiments 1-14, wherein the first L2 reset indication comprises a list of one or more cells, wherein an L2 reset should not be performed if the UE is in one of the listed cells when the UE executes a LTM cell switch.
16. The method of any of embodiments 1-15, wherein executing (704) the LTM cell switch to the first target cell comprises:
determining, based on the first L2 reset indication, whether a L2 reset should be performed during the LTM cell switch to the first target cell;
responsive to determining that an L2 reset should be performed, performing the L2 reset during the LTM cell switch to the first target cell; and
responsive to determining that an L2 reset should not be performed, executing (704) the LTM cell switch to the first target cell without performing the L2 reset.
17. The method of any of embodiments 1-16, wherein the one or more LTM candidate target cells further comprise a second target cell.
18. The method of embodiment 17, wherein the method further comprises:
after executing (704) the cell switch to the first target cell, receiving a second command to execute an LTM cell switch to the second target cell;
obtaining a second L2 reset indication comprising an indication of whether an L2 reset should be performed during the LTM cell switch to the second target cell; and
executing the LTM cell switch to the second target cell according to the second command.
19. The method of embodiment 18, wherein executing the LTM cell switch to the second target cell comprises:
determining, based on the second L2 reset indication, whether a L2 reset should be performed during the LTM cell switch to the second target cell;
responsive to determining that an L2 reset should be performed, performing the L2 reset during the LTM cell switch to the second target cell; and
responsive to determining that an L2 reset should not be performed, executing the LTM cell switch to the second target cell without performing the L2 reset.
20. The method of any of embodiments 1-19, wherein the UE is operating in dual connectivity with a Master Cell Group, MCG, comprising a primary cell, PCell, and at least a Secondary Cell Group, SCG, comprising a primary cell, PSCell.

### Group B Embodiments (1) (First Network Node=Serving DU/S-DU and First/Second Target NN)

21. A method performed by a first network node (e.g., source network node, S-DU, first target network node, second target network node), the method comprising:
sending a first Layer 2, L2, reset indication comprising an indication of whether an L2 reset should be performed during a Layer 1/Layer 2-triggered mobility, LTM, cell switch to a first target cell by a user equipment, UE.
22. The method of embodiment 21, wherein the first L2 reset indication is sent to the UE.
23. The method of any of embodiments 21-22, wherein the first L2 reset indication is sent in a Medium Access Control, MAC, Control Element, CE.
24. The method of embodiment 23, wherein the MAC CE further comprises LTM configuration of one or more LTM candidate target cells, wherein the one or more LTM candidate target cells comprises the first target cell.
25. The method of any of embodiments 21-24, wherein the first L2 reset indication is comprised in an LTM configuration of one or more LTM candidate target cells, wherein the one or more LTM candidate target cells comprises the first target cell.
26. The method of any of embodiments 21-25, wherein the first L2 reset indication is sent in a same or different L2 signalling to a LTM configuration of one or more LTM candidate target cells.
27. The method of any of embodiments 21-26, wherein the first L2 reset indication is sent to a third network node.
28. The method of embodiment 27, wherein the third network node is a Centralized Unit, CU.
29. The method of any of embodiments 21-28, wherein the first network node is a Distributed Unit, DU.
30. The method of any of embodiments 21-29, wherein L2 reset comprises a reset of (only) one or more L2 protocols of a plurality of L2 protocols.
31. The method of any of embodiments 21-30, wherein the UE is operating in a cell group controlled by the first network node.
32. The method of any of embodiments 21-31, wherein the UE is operating in dual connectivity with a Master Cell Group, MCG, comprising a primary cell, PCell, and at least a Secondary Cell Group, SCG, comprising a primary cell, PSCell, wherein the serving cell comprises the PCell and the PSCell.
33. The method of any of embodiments 21-32, wherein L2 reset comprises one or more of: a full L2 reset; a partial L2 reset; a Medium Access Control, MAC, reset; a partial MAC reset; re-establishment; Radio Link Control, RLC, re-establishment; Packet Data Convergence Protocol, PDCP, re-establishment; data recovery; and PDCP data recovery; of one or more L2 protocol sublayers and/or one or more L2 protocol entities configured for a UE.

### Group B Embodiments (2) (Third Network Node=Serving CU)

34. A method performed by a third network node serving a user equipment, UE, the method comprising: sending, to the UE, a Layer 1/Layer 2-triggered mobility, LTM, configuration of one or more LTM candidate target cells, wherein the one or more LTM candidate target cells comprise a first target cell.
35. The method of embodiment 34, wherein the LTM configuration is comprised in a RRC Reconfiguration message.
36. The method of any of embodiments 34-35, wherein the method further comprises:
sending, to the UE, a first L2 reset indication comprising an indication of whether an L2 reset should be performed during a LTM cell switch to a first target cell.
37. The method of embodiment 36, wherein the first L2 indication is sent with the LTM configuration of the one or more LTM candidate target cells.
38. The method of any of embodiments 36-37, wherein the first L2 reset indication is sent in a same or different L2 signalling to the LTM configuration of one or more candidate target cells.
39. The method of any of embodiments 36-38, wherein the first L2 indication is received from a first network node.
40. The method of embodiment 39, wherein the first network node is a Distributed Unit, DU.
41. The method of any of embodiments 36-40, wherein the first L2 indication is received from a first target network node.
42. The method of embodiment 41, wherein the first target network node is a candidate Distributed Unit, DU.
43. The method of any of embodiments 36-42, wherein L2 reset comprises a reset of (only) one or more L2 protocols of a plurality of L2 protocols.
44. The method of any of embodiments 36-43, wherein L2 reset comprises one or more of: a full L2 reset; a partial L2 reset; a Medium Access Control, MAC, reset; a partial MAC reset; re-establishment; Radio Link Control, RLC, re-establishment; Packet Data Convergence Protocol, PDCP, re-establishment; data recovery; and PDCP data recovery; of one or more L2 protocol sublayers and/or one or more L2 protocol entities configured for the UE.
45. The method of any of embodiments 34-44, wherein the third network node is a centralised unit, CU.

### Group C Embodiments

46. A computer program product comprising a computer readable medium having computer readable code embodied therein, the computer readable code being configured such that, on execution by a suitable computer or processor, the computer or processor is caused to perform the method of any of the Group A embodiments or the Group B embodiments.
47. A user equipment, UE, configured to perform the method of any of the Group A embodiments.
48. A user equipment, UE, comprising a processor and a memory, said memory containing instructions executable by said processor whereby said UE is operative to perform the method of any of the Group A embodiments.
49. A network node configured to perform the method of any of the Group B embodiments.
50. A network node comprising a processor and a memory, said memory containing instructions executable by said processor whereby said first RAN node is operative to perform the method of any of the Group B embodiments.
51. A user equipment, comprising:
processing circuitry configured to cause the user equipment to perform any of the steps of any of the Group A embodiments; and
power supply circuitry configured to supply power to the processing circuitry.
52. A network node, comprising:
processing circuitry configured to cause the network node to perform any of the steps of any of the Group B embodiments;
power supply circuitry configured to supply power to the processing circuitry.
53. A user equipment (UE), the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
   a battery connected to the processing circuitry and configured to supply power to the UE.

1-26. (canceled)

27. A method performed by a user equipment (UE), the method comprising:
receiving a Layer 1/Layer 2-triggered mobility (LTM) configuration of one or more LTM candidate target cells, wherein the one or more LTM candidate target cells comprise a first target cell;
receiving a first command to execute an LTM cell switch to the first target cell;
obtaining a first Layer 2 (L2) reset indication comprising an indication of whether an L2 reset is to be performed during the LTM cell switch to the first target cell, wherein the first L2 indication is received with the LTM configuration of the one or more LTM candidate target cells; and
executing the LTM cell switch from a source cell, which is the cell in which the UE receives the first command to execute an LTM switch, to the first target cell according to the first command, wherein executing the LTM cell switch to the first target cell comprises determining, based on the first L2 reset indication, whether L2 reset is to be performed during the LTM cell switch to the first target cell.

28. The method of claim 27, wherein determining whether a L2 reset is to be performed during the LTM cell switch comprises determining whether the source cell is associated, in the LTM configuration of the first target cell, as a cell for which L2 reset is not to be performed.

29. The method of claim 27, wherein the LTM configuration of the first target cell includes an indication of one or more cells from which the UE is to perform LTM cell switch to the first target cell without performing L2 reset.

30. The method of claim 29, comprising:
determining that the source cell is among the one or more cells from which the UE is to perform LTM cell switch to the first target cell without performing L2 reset; and
performing LTM cell switch to the first target cell without performing L2 reset.

31. The method of claim 29, comprising determining that the source cell is not among the one or more cells from which the UE is to perform LTM cell switch to the first target cell without performing L2 reset; and
performing LTM cell switch to the first target cell with L2 reset.

32. The method of claim 27, wherein the LTM configuration is comprised in a Radio Resource Control (RRC) Reconfiguration message.

33. The method of claim 27, wherein L2 reset comprises a reset of one or more L2 protocols of a plurality of L2 protocols.

34. The method of claim 27, wherein L2 reset comprises one or more of: a full L2 reset; a partial L2 reset; a Medium Access Control (MAC) reset; a partial MAC reset; re-establishment; Radio Link Control (RLC) re-establishment; Packet Data Convergence Protocol (PDCP) re-establishment; data recovery; and PDCP data recovery; of one or more L2 protocol sublayers and/or one or more L2 protocol entities configured for the UE.

35. The method of claim 27, wherein the first command is comprised in a Medium Access Control (MAC) Control Element (CE).

36. The method of claim 27, wherein the first L2 reset indication is comprised in the LTM configuration.

37. The method of claim 27, wherein executing the LTM cell switch to the first target cell comprises:
responsive to determining that an L2 reset should be performed, performing the L2 reset during the LTM cell switch to the first target cell; and
responsive to determining that an L2 reset should not be performed, executing the LTM cell switch to the first target cell without performing the L2 reset.

38. A method performed by a network node serving a user equipment (UE), the method comprising:
sending, to the UE, a Layer 1/Layer 2-triggered mobility (LTM) configuration of one or more LTM candidate target cells, wherein the one or more LTM candidate target cells comprise a first target cell, and
sending, to the UE, a first L2 reset indication comprising an indication of whether an L2 reset should be performed during a LTM cell switch to a first target cell, wherein the first L2 indication is sent with the LTM configuration of the one or more LTM candidate target cells.

39. A user equipment (UE), comprising a processor and a memory, said memory containing instructions executable by said processor whereby said UE is operative to:
receive a Layer 1/Layer 2-triggered mobility (LTM) configuration of one or more LTM candidate target cells, wherein the one or more LTM candidate target cells comprise a first target cell;
receive a first command to execute an LTM cell switch to the first target cell;
obtain a first Layer 2 (L2) reset indication comprising an indication of whether an L2 reset is to be performed during the LTM cell switch to the first target cell, wherein the first L2 indication is received with the LTM configuration of the one or more LTM candidate target cells; and
execute the LTM cell switch from a source cell, which is the cell in which the UE receives the first command to execute an LTM switch, to the first target cell according to the first command, wherein executing the LTM cell switch to the first target cell comprises determining, based on the first L2 reset indication, whether a L2 reset should be performed during the LTM cell switch to the first target cell.

40. The UE of claim 39, wherein the UE is operative to determine whether a L2 reset is to be performed during the LTM cell switch by determining whether the source cell is associated, in the LTM configuration of the first target cell, as a cell for which L2 reset is not to be performed.

41. The UE of claim 39, wherein the LTM configuration of the first target cell includes an indication of one or more cells from which the UE is to perform LTM cell switch to the first target cell without performing L2 reset.

42. The UE of claim 41, wherein the UE is further operative to:
determine that the source cell is among the one or more cells from which the UE is to perform LTM cell switch to the first target cell without performing L2 reset; and
perform LTM cell switch to the first target cell without performing L2 reset.

43. The UE of claim 41, wherein the UE is further operative to:
determine that the source cell is not among the one or more cells from which the UE is to perform LTM cell switch to the first target cell without performing L2 reset; and
perform LTM cell switch to the first target cell with L2 reset.

44. The UE of claim 39, wherein the LTM configuration is comprised in a Radio Resource Control (RRC) Reconfiguration message.

45. The UE of claim 39, wherein L2 reset comprises a reset of one or more L2 protocols of a plurality of L2 protocols.

46. The UE of claim 39, wherein L2 reset comprises one or more of: a full L2 reset; a partial L2 reset; a Medium Access Control (MAC) reset; a partial MAC reset; re-establishment; Radio Link Control (RLC) re-establishment; Packet Data Convergence Protocol (PDCP) re-establishment; data recovery; and PDCP data recovery; of one or more L2 protocol sublayers and/or one or more L2 protocol entities configured for the UE.
